(19) United States
(12) Patent Application Publication
(10) Pub. No.: US 2022/0111524 A1
(43) Pub. Date: Apr. 14, 2022

(54) SAFETY SYSTEM OF ROBOT IN AUTO MODE AND METHOD THEREFOR

(71) Applicant: TECHMAN ROBOT INC., Taoyuan City (TW)

(72) Inventor: Ting-Ya Hsiao, Taoyuan City (TW)

(73) Assignee: TECHMAN ROBOT INC., Taoyuan City (TW)

(21) Appl. No.: 17/384,826

(22) Filed: Jul. 26, 2021

(30) Foreign Application Priority Data
Oct. 14, 2020 (TW) 109135846

(51) Int. Cl. B25J 9/16; B25J 9/00; B25J 13/08

(52) U.S. Cl. CPC B25J 9/1674; B25J 13/086; B25J 9/1664; B25J 9/0081

(57) ABSTRACT

A robot safety system and method for an auto mode are used to set a stop state process which the robot operating the auto mode enters into a waiting state. A remind mechanism reminds an activation mechanism to start setting the robot to a safe state. The safety state is aborted by a hand-guiding enable device, and the robot may be hand guided to ensure the collaborative safety at the auto mode.

### CROSS REFERENCE TO RELATED APPLICATION

This non-provisional application claims priority of Taiwan patent application No. 109135846, filed on 14 Oct. 2020, included herein by reference in its entirety.

### BACKGROUND OF THE INVENTION

### 1. Field of the Invention

The present invention relates to a safety system of a robot and a method thereof, and in particular, to a safety system of a robot in an auto mode and a method thereof for a user to guide the robot to perform a collaborative operation.

### 2. Description of the Prior Art

As the robotics technology continues to advance, factories employ robots to assist operators to achieve fast processing, assembly and manufacturing and to improve factory production efficiency. However, the fast movements of the robots can seriously affect the safety of the collaborative operators. Therefore, various countries have imposed strict safety regulations for the operators to work safely.

Please refer to FIG. 4. In the related art, in order to teach the robot 1 how to operate, a hand-guiding switch 2 is arranged at an end of the robot 1. The hand-guiding switch 2 is usually designed as a hold-to-run switch or a software switch. The hand-guiding switch 2 is electrically or communicatively coupled to the controller 3 of the robot 1. When the teaching device 4 sets the robot 1 to a teaching mode, if a user presses the hand-guiding switch 2, the controller 3 will be set off by a signal to switch the robot 1 from a standstill state to hand-guiding mode. The hand-guiding mode has been implemented by several ways in the related art. For example, an encoder and a motor current sensor of an actuator in each segment 5 of the robot 1 perform calculations and compensations to determine a force applied to each joint or a hand-guiding force applied to the end, thereby controlling the robot 1 to move by following a hand-guiding operation. The robot 1 is taught about how to operate by hand guiding the robot 1 to positions and recording the positions, or by recording a path of hand-guiding. When the hand-guided switch 2 is released, the robot 1 is switched from the hand-guiding mode and returns to the standstill state.

In order to comply with the requirements of the safety standard ISO 10218-1, a teaching device 4 of the robot 1 in the related art includes an enabling device 6 to protect the collaborative operator in the teaching mode. The enabling device 6 is usually located at the teaching device 4 and is a three-position switch including 3 pressing stages, namely a fully released position, an intermediate position, and a pressed position, of which only the intermediate position may enable the robot 1 to perform a teaching operation. When in the fully released position or the pressed position, a signal is electrically or communicatively transmitted to the controller 3, a safety system 7 interrupts the teaching operation to stop the robot 1 from moving and keep robot 1 not acting rashly via stand still monitoring when the actuator is still powered. If it is found that the robot is moving, the safety system 7 will cut off the power to the actuator of the robot 1 to ensure the safety of the operator during the teaching operation.

However, the robot in the related art only provides safety protection in the teaching mode, but not other states in the auto mode. In the auto mode, sometimes it is required for a user to work collaboratively with the robot, such as hand guiding the robot to reach an operation area to perform an operation, or hand guiding collaborative robot to carry a heavy object after the robot lifts the heavy object, or hand guiding the collaborative robot to demonstrate a variety of collaborative operations. A solution to ensure the safety of users during a hand-guiding operation, especially in the auto mode is in need to ensure safety and allow users to perform a collaborative operation. Therefore, there are still issues to be solved urgently for the safety system and method of the robot in the auto mode.

### SUMMARY OF THE INVENTION

The objective of the present invention is to provide a safety system of a robot in an auto mode. By programming a standstill state program, the robot running in the auto mode enters a waiting state, and a reminder mechanism is set to remind a user to start an activation mechanism, for that the robot to enter a safe state, and a hand-guiding enable device is utilized to hand-guide the robot to ensure the safety of a collaborative operation in the auto mode.

Another objective of the present invention is to provide a safety method of a robot in an auto mode. The method comprises a controller counting a waiting time, and automatically setting the robot to a safe state upon the waiting time exceeding a time limit, so as to enhance the safety of a collaborative operation in the auto mode.

Another objective of the present invention is to provide a safety method of a robot in an auto mode. The method comprises a user restarting an activation mechanism to set the robot back to the auto mode, so as to increase the safety of a collaborative operation in the auto mode.

In order to achieve the objectives of the invention, the safety system of the robot in the auto mode includes a multi-segment robot, the robot including a movable end, and each segment including an actuator and a position sensor; a controller coupled to the robot, and configured to control the actuator and the position sensor of the each segment, move the movable end of the robot, and store a standstill state program of the auto mode; a teaching device coupled to the controller; a human-machine interface coupled to the controller, and configured to display an editing program, an operating program or a control screen; a hand-guiding enable device comprising an enabling switch configured to enable and initiate a hand-guiding operation; and a safety module disposed in the controller, electrically or communicatively coupled to the hand-guiding enabling device and the position sensor, the hand-guiding enabling device sending an electrical or communication signal according to a state of the hand-guiding enable device. When the robot executes the standstill state program in the auto mode, the robot enters a standstill state and then a safe state, and the hand-guiding enable device is pressed to set the same to a turn-on state to hand-guide the robot.

In the safety system, the safety module is electrically or communicatively coupled to the position sensor of the each segment of the robot, and is configured to receive a signal from the position sensor to monitor a movement of the robot. The standstill state program is pre-programmed or programmed by the human-machine interface. The safety system uses the reminder mechanism in the standstill state to remind that the robot is in the waiting-to-be-activated state, and activate the enabling mechanism of the safety system by a user's instruction to set the robot to the safe state. The reminder mechanism is set off by a light or a sound of the controller, a display screen of the human-machine interface, a predetermined repeated movement of the robot, a notification signal of an IO interface, or a reminder signal notified by communication. The activation mechanism is provided at the movable end of the robot, the controller, the teaching device or the human-machine interface. The activation mechanism is an IO interface, a communication software/hardware switch, or a sensor sensing a movement of a user's body part for obtaining an indication signal. The reminder mechanism stops when the robot enters the safe state. The controller generates a safety alert of a light indication, a sound indication or a movement to indicate that the robot has entered the safe state.

The controller automatically instructs the robot to enter the safe state upon determining that the robot has entered the standstill state for a predetermined period of time. Upon the robot being hand-guided in the auto mode, the hand-guiding enable device is in the turn-off state to return to the safe state, and an operation is ended by restarting the activation mechanism. Alternatively, upon the robot being hand-guided in the auto mode, the hand-guiding enable device is in the turn-off state to return to the safe state, and the robot returns to the auto mode and automatically proceed to a next operation upon the controller counting a predetermined time. The hand-guiding enable device includes an enabling switch and a software switch and/or a hardware switch for use to start a hand-guiding operation. The hand-guiding enable device is set at the movable end of the robot, the teaching device, or a port electrically coupled to an external enabling device.

The safety method of the robot in the auto mode includes storing a standstill state program, operating the robot in an auto mode to perform the standstill state program to enter a standstill state, the robot entering a safe state, setting a hand-guiding enable device to a turn-on state for the robot to abort the safe state and perform a hand-guiding operation of the robot.

The safety method further includes after the robot enters the standstill state, reminding that the robot is in a waiting state. In the waiting state, if an instruction of enabling activation mechanism is received, the robot enters the safe state, and if an instruction of enabling activation mechanism is not received, the robot remains at the waiting state. After the robot enters the standstill state, count the time. If the time exceeds a time limit, set the robot directly to the safe state, and if the time is within the time limit, continue to count the time. In the hand-guiding operation, if the hand-guiding enable device is in a turn-off state, the robot enters the safe state, and if the hand-guiding enable device is not in the turn-off state, continue the hand-guiding operation of the robot. If the operation is finished, the robot returns to the auto mode, and automatically performs a next operation, if the operation is not finished, the robot continues to enter the safe state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a safety system of a robot in an auto mode according to an embodiment of the present invention.

FIG. 2 is a schematic diagram of control functions of the safety system according to an embodiment of the present invention.

FIG. 3 is a flowchart of a safety method of a robot in an auto mode according to an embodiment of the present invention.

FIG. 4 is a schematic diagram of teaching a robot by a hand-guiding operation in a related art.

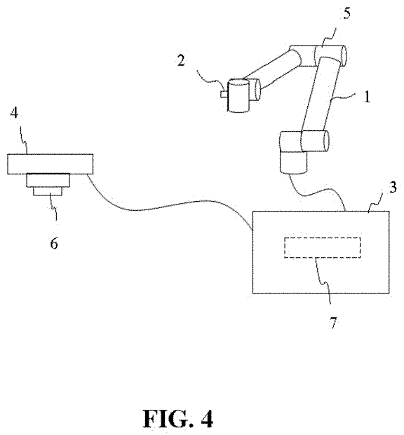

### DETAILED DESCRIPTION

In order to comply with the requirements of the safety standard ISO 10218-1, the robot has the following operation modes: an auto mode and a manual (or teaching) mode. The auto mode is defined as a robot automatically performing programs in an automated production process, and a user is a production line operator. At present, hand-guiding operations have been adopted in the auto mode to facilitate production line operators to perform the following tasks: a hand-guiding movement (e.g., hand guiding the robot to the next starting point of an operation), a hand-guiding demonstration (e.g., hand guiding an operation path), a hand-guiding collaborative operation (e.g., the robot lifts a weight and a user hand guides the robot to a placement position). The hand-guiding operations in the auto mode are not the teaching operation specified in the safety specification, but hand-guided operations in an automated production process.

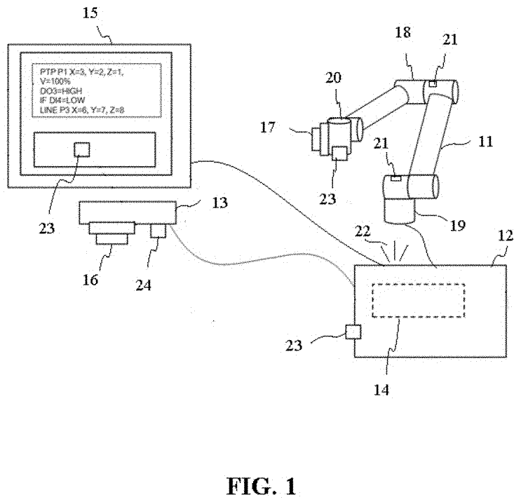

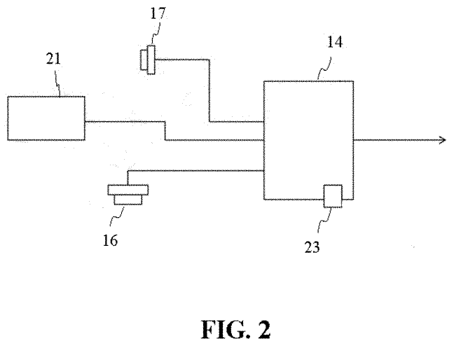

Please refer to FIGS. 1 and 2. FIG. 1 is a schematic diagram of a safety system 10 of a robot 11 in an auto mode according to an embodiment of the present invention, and FIG. 2 is a schematic diagram of control functions of the safety system according to an embodiment of the present invention. In FIG. 1, the safety system 10 of the present invention includes the robot 11, a controller 12, a teaching device 13, a safety module 14, a human-machine interface 15, an enabling device 16, and a hand-guiding enable device 17. The robot 11 may perform a hand-guiding operation, and has a plurality of segments 18. One end of the robot 11 is a fixed base 19, and the other end of the robot 11 is a movable end 20. The robot 11 is coupled to a controller 12 including a safety module 14. The controller 12 controls the movable end 20 of the robot 11 by controlling an actuator and a position sensor 21 in each segment 18. The teaching device 13 is coupled to the controller 12 to operate and control the robot 11. The human-machine interface 15 is coupled to the controller 12 to display an editing program, an operating program or a control screen. In some embodiments, a general enabling device 16 is provided at the teaching device 13, and a hand-guiding enable device 17 is provided at the movable end 20 of the robot 11. While in the embodiment the hand-guiding enable device 17 is provided at the movable end 20 of the robot 11, the hand-guiding enable device 17 may also be provided at the teaching device 13, or may include a port electrically coupled to an external enabling device.

In FIG. 2, the safety module 14 is electrically or communicatively coupled to the enabling device 16, the hand-guiding enable device 17 and the position sensor 21 via the controller 12. The enabling device 16 may be operated in a turn-on state or a turn-off state. When the enabling device 16 is operated in the turn-on state, the safety module 14 may abort a safe state of the robot 11 according to the operation mode of the robot 11. When the enabling device 16 is operated in the turn-off state, the safety module 14 may halt the robot 11 and set the robot 11 to the safe state according to the operation mode of the robot 11. In addition to the safety function provided by the general enabling device 16, the hand-guiding enable device 17 may also provide the function of hand-guiding the robot 11 in the turn-on state. The hand-guiding enable device 17 may include an enabling switch for enabling and activating a hand-guiding operation, or may include an enabling switch for enabling the hand-guiding operation and a software or hardware switch for initiating the hand-guiding operation. The safety module 14 is electrically or communicatively coupled to the position sensor 21 of each segment 18 of the robot 11, and receives signals from the respective position sensors 21 to monitor the movement of the robot 11.

The safety module 14 may selectively set the robot 11 to one of three types of the safe states. The three types of the safe states include types 0, 1 and 2. The type 0 of the safe state provides a power-off shutdown function, in which the safety module 14 directly shuts down the power to the actuator when the safety module 14 determines that the robot 11 should enter the safe state. The type 1 of the safe state provides an advanced power-off shutdown function, in which the power to the actuator is shut down after a deceleration command is issued to the controller 12 for a fixed period of time or after a deceleration motion of the robot 11 is achieved when the safety module 14 determines that the robot 11 should enter the safe state. The type 2 of the safe state provides a non-power-off shutdown function, in which a standstill monitoring safety function is activated, the position sensor 21 continuously monitors the movement of the robot 11, the power to the actuator is shut down upon detecting the robot 11 generates a movement after a deceleration command is issued to the controller 12 for a fixed period of time or after a deceleration motion of the robot 11 is achieved when the safety module 14 determines that the robot 11 should enter the safe state.

In the embodiment, the human-machine interface 15 specifies a program to be automatically operated by the robot 11 using text or graphical commands. The controller 12 may be programmed via the human-machine interface 15, or may be pre-programmed externally for the robot 11 to run a standstill state program, such as “pause”, “wait” or “waiting for enabling a hand-guiding operation” programs dedicated to the hand-guiding operation in the auto mode. The programs may be saved in the controller 12. After the robot 11 automatically runs the standstill state program, the robot 11 enters a standstill state, waiting for a user to activate a collaborative operation. In the embodiment, when the robot 11 waits for a user to activate the collaborative operation, in order to remind the user that the robot 11 is waiting, the safety system 10 uses a light indication or a sound indication 22 generated by the controller 12, a display screen generated by the human-machine interface 15, a predetermined repeating movement of the robot 11, a notification sent by an input/output (IO) interface, or a communication notification to remind the user of the robot 11 having entered a state of waiting for the user to activate a collaborative operation.

After the robot 11 automatically runs the standstill state program, an activation mechanism that enables the user to instruct the robot 11 to enter the safe state is employed to ensure a safe collaborative operation between the user and the robot 11. That is, an IO interface or a communication software/hardware switch 23 is arranged at the movable end 20 of the robot 11, the controller 12, the teaching device 13 or the human-machine interface 15, or the sensor 24 is used to sense a movement of a user's body part to obtain an instruction, e.g., by detecting a gesture, and the robot 11 is instructed to enter the safe state by the activation mechanism such as pressing the switch 23 or the sensor 24 sensing the gesture. Alternatively, if the controller 12 displays a reminder mechanism of the light indication, the sound indication, and/or the movements for a predetermined period of time, and yet still receives no instruction from the user to set the robot 11 into the safe state, the controller 12 may set the robot 11 to enter the safe state automatically to ensure the safety. Once the robot 11 enters the safe state, the reminder mechanism will be stopped immediately, or the controller 12 displays a safety alert such as a light indication, a sound indication, and/or a movement for the user to be certain that the robot 11 has entered the safe state.

When the robot 11 automatically runs the standstill state and then enters the safe state, the safety module 14 handles basic operations of the enabling device 16 and the hand-guiding enable device 17 as follows. In the auto mode, the enabling device 16 cannot be used, that is, the robot 11 is disabled regardless of the enabling device 16 being in the turn-on state or the turn-off state. When the hand-guiding enable device 17 is in the turn-off state, the robot 11 is actuated into the safe state. When the hand-guiding enable device 17 is in the turn-on state, the robot 11 is actuated to abort the safe state and is able to be hand-guided. Therefore, the hand-guiding enable device 17 may be set to the turn-on state, the robot 11 may abort the safe state to perform a hand guiding operation, for example, by hand guiding a movement of the robot 11 to a starting point of the next operation, or by the robot 11 lifting a weight and hand guiding the robot 11 to a placement position. Upon completion of the hand-guiding operation of the robot 11 in the auto mode, the hand-guiding enable device 17 is set to the turn-off state, and the actuating robot 11 will immediately return to the safe state, and then the activation mechanism may be actuated by pressing the switch 23 or the sensor 24 sensing the gesture, so as to indicate the end of the hand-guiding operation and automatically proceed to the next operation.

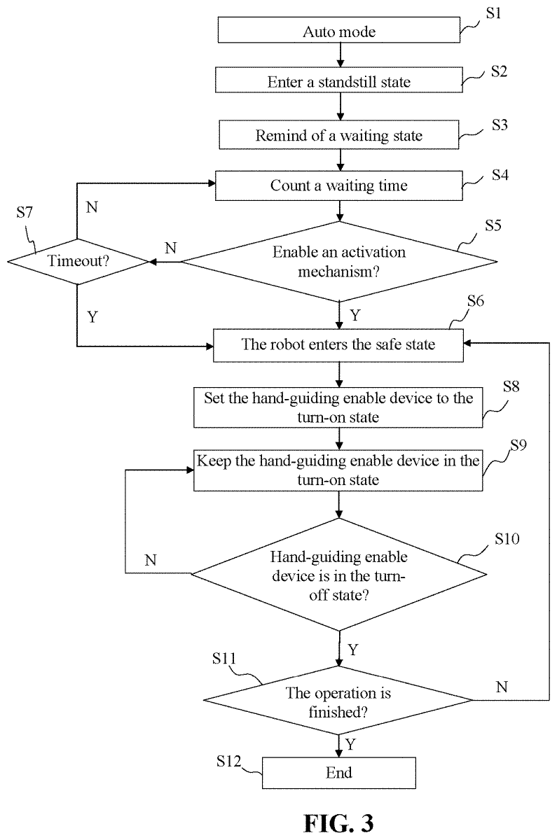

FIG. 3 is a flowchart of a safety method of a robot in an auto mode according to an embodiment of the present invention. Steps of the safety method of the robot in the auto mode are detailed as follows: Step S1: store a pre-programmed standstill state program. Step S2: set the robot to the auto mode, and the robot runs the standstill state program to enter the standstill state. Step S3: remind the user of the robot being in the waiting state. Step S4: count the waiting time. Step S5: check whether an instruction for enabling the activation mechanism is received? If so, go to Step S6 and the robot enters the safe state. If not, go to Step S7 and check whether the waiting time exceeds the time limit? If the waiting time has not exceeded the time limit, go back to Step S4 and continue to count the waiting time. If the waiting time has exceeded the time limit, go to Step S6 and the robot enters the safe state directly; then go to Step S8 to set the hand-guiding enable device to the turn-on state for the robot to abort the safety state. Step S9: continue to keep the hand-guiding enable device in the turn-on state, and perform a hand-guiding operation to the robot. Step S10: check whether the hand-guiding enable device is in the turn-off state? If not, return to Step S9 and continue the hand-guiding operation of the robot. If so, go to Step S11 to check whether the operation is finished? If the operation is not finished, go back to Step S6 and continue to set the robot to the safe state. If the operation is finished, go to Step S12 to end the operation, set the robot to the auto mode, and the robot automatically proceeds to the next operation.

Therefore, in the present invention, the safety system and safety method of the robot in the auto mode may enable the robot 10 in the auto mode to enter the waiting state using the standstill state program, and set the reminder mechanism to remind the user to activate the activation mechanism. The activation mechanism is used to set the robot to enter the safe state, while the controller counts the waiting time. If the waiting time exceeds the time limit, the robot automatically enters the safe state. The hand-guiding enable device is used to hand guide the robot. When the operation is finished, the user can restart the activation mechanism to set the robot to the auto mode, so as to ensure the safety of collaborative operations in the auto mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A safety system of a robot in an auto mode comprising:
a robot comprising a plurality of segments and a movable end, each segment being provided with an actuator and a position sensor;
a controller coupled to the robot, and configured to control the actuator and the position sensor of the each segment, move the movable end of the robot, and store a standstill state program of the auto mode;
a teaching device coupled to the controller;
a human-machine interface coupled to the controller, and configured to display an editing program, an operating program or a control screen;
a hand-guiding enable device comprising an enabling switch configured to enable and initiate a hand-guiding operation; and
a safety module disposed in the controller, electrically or communicatively coupled to the hand-guiding enabling device and the position sensor, and the hand-guiding enabling device sending an electrical or communication signal to the safety module according to a state of the hand-guiding enable device;
wherein when the robot executes the standstill state program in the auto mode, the robot enters a standstill state and then a safe state, and the hand-guiding enable device is pressed to set the same to a turn-on state to hand-guide the robot.

2. The safety system of claim 1, wherein the safety module is electrically or communicatively coupled to the position sensor of the each segment of the robot, and is configured to receive signals from the position sensors to monitor a movement of the robot.

3. The safety system of claim 1, wherein the standstill state program is pre-programmed or programmed by the human-machine interface.

4. The safety system of claim 1, wherein the safety system enters a waiting-to-be-activated state from the standstill state, and receives an instruction of a user to initiate an activation mechanism of the safety system to enable the robot to enter the safe state.

5. The safety system of claim 4, wherein the activation mechanism is provided at the movable end of the robot, the controller, the teaching device or the human-machine interface.

6. The safety system of claim 5 wherein the activation mechanism is an input/output (IO) interface, a communication software or hardware switch, or a sensor, the sensor being configured to sense a movement of a user's body part to obtain an indication signal.

7. The safety system of claim 1, wherein during the standstill state a reminder mechanism is utilized to remind that the robot has entered a waiting-to-be-activated state.

8. The safety system of claim 7, wherein the reminder mechanism is indicated by a light indication or a sound indication of the controller, a display screen of the human-machine interface, a predetermined repeating movement of the robot, an notification signal of an IO interface, or a reminder signal notified by communication.

9. The safety system of claim 7, wherein the reminder mechanism is disabled when the robot enters the safe state.

10. The safety system of claim 1, wherein the controller automatically instructs the robot to enter the safe state upon determining that the robot has entered the standstill state for a predetermined period of time.

11. The safety system of claim 1, wherein the controller generates a safety alert of a light indication, a sound indication or a movement of the robot to indicate that the robot has entered the safe state.

12. The safety system of claim 1, wherein upon completion of a hand-guiding operation of the robot in the auto mode, the hand-guiding enable device is set to a turn-off state to return to the safe state, and the hand-guiding operation is ended by restarting the activation mechanism.

13. The safety system of claim 1, wherein upon completion of a hand-guiding operation of the robot in the auto mode, the hand-guiding enable device is set to a turn-off state to return to the safe state, and the robot returns to the auto mode and automatically proceed to a next operation upon the controller counting a predetermined period of time.

14. The safety system of claim 1, wherein the hand-guiding enable device comprises an enabling switch and a software or hardware switch for use to initiate a hand-guiding operation.

15. The safety system of claim 14, wherein the hand-guiding enable device is disposed at the movable end of the robot, the teaching device, or a port electrically coupled to an external enabling device.

16. A safety method of operating a robot in an auto mode, the safety method comprising:
storing a standstill state program;
operating the robot in an auto mode to perform the standstill state program to enter a standstill state;
the robot entering a safe state; and
setting a hand-guiding enable device to a turn-on state for the robot to abort the safe state and perform a hand-guiding operation of the robot.

17. The safety method of claim 16, further comprising after the robot enters the standstill state, reminding that the robot is in a waiting state.

18. The safety method of claim 17, further comprising in the waiting state, the robot entering the safe state if an instruction of enabling an activation mechanism is received, and the robot remaining in the waiting state if the instruction of enabling the activation mechanism is not received.

19. The safety method of claim 16, further comprising counting a time after the robot enters the standstill state.

20. The safety method of claim 19, further comprising if the time exceeds a time limit, setting the robot directly to the safe state, and if the time is within the time limit, continuing to count the time.

21. The safety method of claim 16, wherein the hand-guiding operation of the robot comprises if the hand-guiding enable device is in a turn-off state, the robot entering the safe state, and if the hand-guiding enable device is not in the turn-off state, continuing the hand-guiding operation of the robot.

22. The safety method of claim 16 further comprising if an operation is finished, the robot returning to the auto mode, and automatically performing a next operation, if the operation is not finished, the robot continuing to enter the safe state.

23. The safety method of claim 16, further comprising the controller generating a safety alert to indicate that the robot has entered the safe state.
